(19) United States
(12) Patent Application Publication
(10) Pub. No.: US 2026/0284883 A1
(43) Pub. Date: Sep. 24, 2026

(54) TETHERED TRAJECTORY GENERATION FOR ROBOTS

(71) Applicant: Intel Products IP LLC, Santa Clara, CA (US)

(72) Inventors: Rodrigo Aldana Lopez, Zapopan (MX); Leobardo Campos Macias, Guadalajara (MX); Rafael de la Guardia Gonzalez, Leioa (MX); David Gomez Gutierrez, Tlaquepaque (MX)

(21) Appl. No.: 19/688,360

(22) Filed: May 26, 2026

Related U.S. Application Data
(60) Provisional application No. 63/810,926, filed on May 23, 2025.

(51) Int. Cl. B25J 9/16

(52) U.S. Cl. CPC B25J 9/1666; B25J 9/161; B25J 9/1651; B25J 9/1676

(57) ABSTRACT

A robotic system, including: a path planner configured to generate a collision-free path for a robot; a virtual controller configured to generate a time-dependent trajectory based on the collision-free path, wherein the trajectory is tethered to the collision-free path subject to dynamic constraints of the robot, is constrained to remain within a feasibly safe region in state space, and is executable by the robot.

### BACKGROUND

There exists a demand for high-performance trajectory generation methods for robotic systems operating in complex environments. Such methods are configured to satisfy stringent safety constraints while providing formal safety guarantees. Unlike a path, which is a static sequence of configurations connecting a start and end point without considering temporal evolution, a trajectory accounts for time-dependent dynamics such as velocity, acceleration, and higher-order derivatives. These dynamic aspects are relevant for real-world robotic control and effective avoidance of moving obstacles.

Existing methods that attempt to generate trajectories directly in the high-dimensional kinodynamic space, whether through optimization or sampling, are typically inefficient. These approaches face significant computational challenges due to the complexity of satisfying both geometric and dynamic constraints simultaneously. As a result, systems adopt hybrid approaches: first computing a collision-free path in configuration space, and then generating a time-parameterized trajectory that adheres to dynamic constraints such as limits on velocity and acceleration. While artificial intelligence (AI)-based approaches have shown promise in learning effective motion strategies, they often lack guarantees regarding the satisfaction of physical and dynamic constraints imposed by the robot's actuators and structure.

Common trajectory generation techniques such as quadratic programming (QP) and polynomial fitting tend to produce conservative solutions. These approaches often fail to fully exploit the robot's dynamic capabilities, leading to unnecessarily slow motion and reduced overall performance in time-critical applications.

### BRIEF DESCRIPTION OF THE FIGURES

FIG. 1 illustrates a block diagram of a robotic system with tether-based trajectory generation, in accordance with aspects of the disclosure.

FIG. 2 illustrates a schematic diagram of a robotic arm and a workspace, in accordance with aspects of the disclosure.

FIG. 3 illustrates a transformation of a time-independent path into a dynamic time-dependent trajectory, in accordance with aspects of the disclosure.

FIG. 4 illustrates a generated trajectory that remains proximate to a reference point on a path, in accordance with aspects of the disclosure.

FIG. 5 illustrates a graph depicting velocity as a function of path error, in accordance with aspects of the present disclosure.

FIG. 6 illustrates graph depicting velocity as a function of path error of controller behavior in state space, in accordance with aspects of the disclosure.

FIG. 7 illustrates a block diagram of a free controller, in accordance with aspects of the disclosure.

FIG. 8 illustrates a proof of concept, in accordance with aspects of the disclosure.

FIG. 9 illustrates a block diagram of a system in accordance with aspects of the disclosure.

### DETAILED DESCRIPTION

The present disclosure relates to systems and methods for robotic trajectory generation that integrate learning-based control with safety enforcement. By combining these approaches, robots can operate at their dynamic limits while maintaining rigorous safety guarantees through a “tethering” mechanism that couples path planning with trajectory generation. This enables significantly faster and more efficient robot movement compared to traditional methods, with demonstrated speed improvements of 10-100× while ensuring safety constraints are satisfied.

The disclosed system employs a hybrid architecture that first generates a collision-free path and then produces a time-parameterized trajectory that respects dynamic constraints like velocity and acceleration limits. A virtual control system applies higher-order dynamics to the path through a tethering mechanism that keeps the trajectory within a feasibly safe region. This region is defined by both spatial bounds relative to the planned path and dynamic limits on the robot's motion. Within these constraints, a neural network-based controller optimizes performance while a safety controller ensures the trajectory remains feasible, enabling aggressive yet safe robot motion that fully exploits the system's dynamic capabilities.

### I. Robotic System

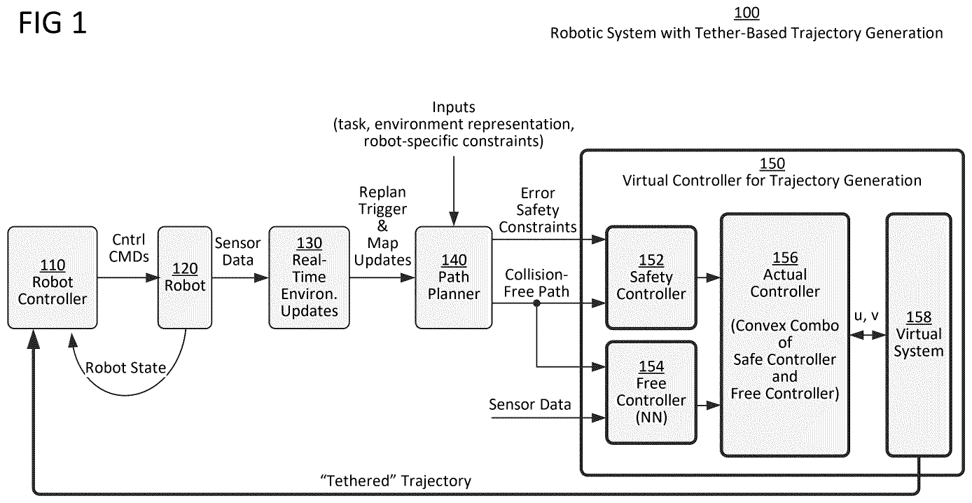

FIG. 1 illustrates a block diagram of a robotic system 100 with tether-based trajectory generation, in accordance with aspects of the disclosure.

“Robot,” as used herein, refers to any system capable of perceiving its environment, processing information, and executing actions based on control inputs, including but not limited to industrial manipulators, mobile ground robots (e.g., wheeled or legged robots), aerial vehicles (e.g., unmanned aerial vehicles or drones), autonomous or semi-autonomous vehicles (e.g., self-driving cars), marine robots (e.g., underwater remotely operated vehicles), and humanoid or service robots. The robot may include one or more sensors, actuators, processors, communication interfaces, and motion control systems, and may operate under full autonomy, partial autonomy, or teleoperation.

The robotic system 100 receives inputs including task requirements, environment representation, and robot-specific constraints. A path planner 140 generates a collision-free path, which is provided to a virtual controller 150 for trajectory generation. The virtual controller 150 includes a safety controller 152, a free controller 154 implemented, for example, as a neural network, and an actual controller 156 that combines outputs from both the safety controller 152 and the free controller 154. A virtual system 158 simulates virtual differential equations that represent simplified dynamics for trajectory generation purposes, rather than the physical dynamics of the robot 120. The control commands (u,v) from the actual controller 156 are applied to these virtual systems, one governing the arc-length parameter derivative and one governing the time-parameterized trajectory, to generate the “tethered” trajectory. This generated trajectory is then provided to the robot controller 110 for execution by the physical robot 120 using conventional control methods.

The robotic system 100 includes a robot controller 110 that receives the generated trajectory and produces control commands for the physical robot 120. The robot 120 provides state feedback and sensor data, which is processed by a real-time environment updates module 130. This module 130 provides map updates that can trigger replanning through the path planner 140.

The virtual controller 150 maintains safety constraints while optimizing performance through the interaction between the safety controller 152 and learning-based free controller 154. The actual controller 156 combines these outputs to generate trajectories that remain within feasible bounds while exploiting the robot's full dynamic capabilities. This “tethered” approach allows the trajectory to closely track the planned path while respecting velocity, acceleration and other dynamic constraints.

In some aspects, the virtual controller 150 may scale trajectory generation efficiently with increasing degrees of freedom n of the robot 120. This efficient scaling is enabled by the decoupling of path planning from trajectory generation. The path planner 140 operates in the lower-dimensional configuration space to generate the collision-free path, while the virtual controller 150 generates the time-parameterized trajectory by applying higher-order dynamics to this path. Because the virtual controller 150 operates on simplified integrator dynamics (as described in Equations 1 and 2 below) rather than the full physical dynamics of the robot 120, the computational complexity of trajectory generation does not grow prohibitively with the robot's degrees of freedom. Additionally, the neural network-based free controller 154 may be implemented as a lightweight architecture, such as a multilayer perceptron with a limited number of trainable parameters, which maintains computational efficiency regardless of n. In contrast, prior kinodynamic planning methods that generate trajectories directly in the higher-order kinodynamic space become intractable for robots with many degrees of freedom due to the high dimensionality of the search space. Similarly, optimization-based planning methods become prohibitively expensive as the optimization problem grows significantly with increasing degrees of freedom. The disclosed approach addresses these limitations by confining the computationally intensive path planning to the configuration space while the trajectory generation operates on the simplified virtual dynamics, thereby enabling scalable trajectory generation for robots with arbitrary degrees of freedom.

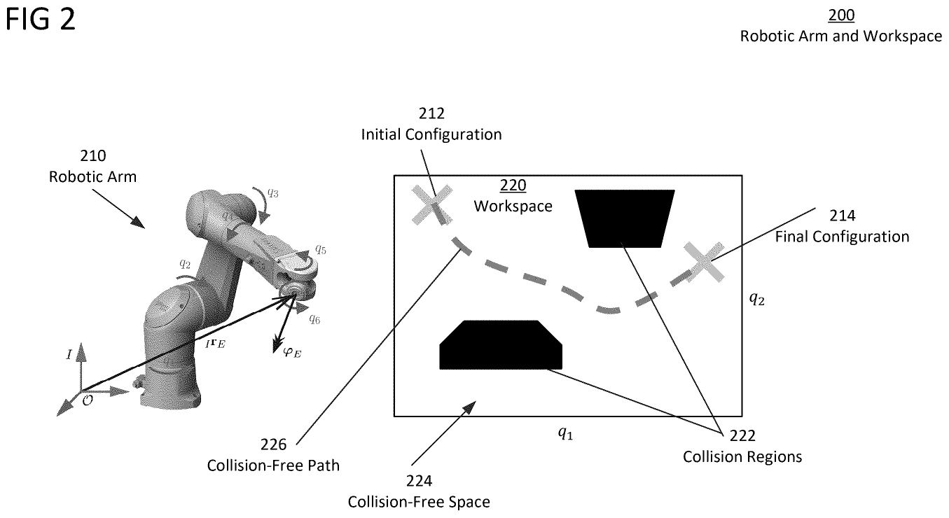

FIG. 2 illustrates a schematic diagram of a robot 210 and a workspace 220 (together, 200), in accordance with aspects of the disclosure.

Consider a robot 210 with n degrees of freedom as shown in the figure. The workspace 220 shows an n-dimensional space, with one axis per coordinate qᵢ comprising the complete configuration of the robot 210. In the workspace 220, collision regions 222 represent areas where collisions with objects in the environment occur or where self-collisions occur. The goal is to drive the robot 210 from an initial configuration 212 to a final configuration 214 through a collision-free trajectory.

The workspace 220 demonstrates the relationship between physical robot configuration and workspace coordinates. The left-hand portion shows the robot 210 with multiple degrees of freedom, where joint angles q₁, q₂, etc. define the robot 210's configuration. Coordinate frames and axes indicate the robot 210's base frame and end-effector position.

The right-hand portion depicts the workspace 220 as a two-dimensional configuration space with axes q₁ and q₂ representing joint angles. Black regions indicate collision regions 222 where the robot 210 would either collide with obstacles in the environment or experience self-collisions. The white space represents the collision-free configuration space 224.

The workspace 220 shows an initial configuration 212 and final configuration 214 (marked with X's) that the robot 210 moves between. A dashed line represents a collision-free path 226 connecting these configurations 212, 214 while avoiding the collision regions 222. This path 226 provides a geometric solution for moving between the initial configuration 212 and final configuration 214, but does not yet incorporate time-dependent aspects like velocity and acceleration that are for actual robot motion.

Here, there is a differentiation between a path and a trajectory. A collision-free path 226 is just a set of lines in the workspace 220 connecting the initial configuration 212 and the final configuration 214, which do not cross the collision regions 222. In contrast, a trajectory is a time-dependent function, which includes information about velocity, acceleration, jerk, etc.

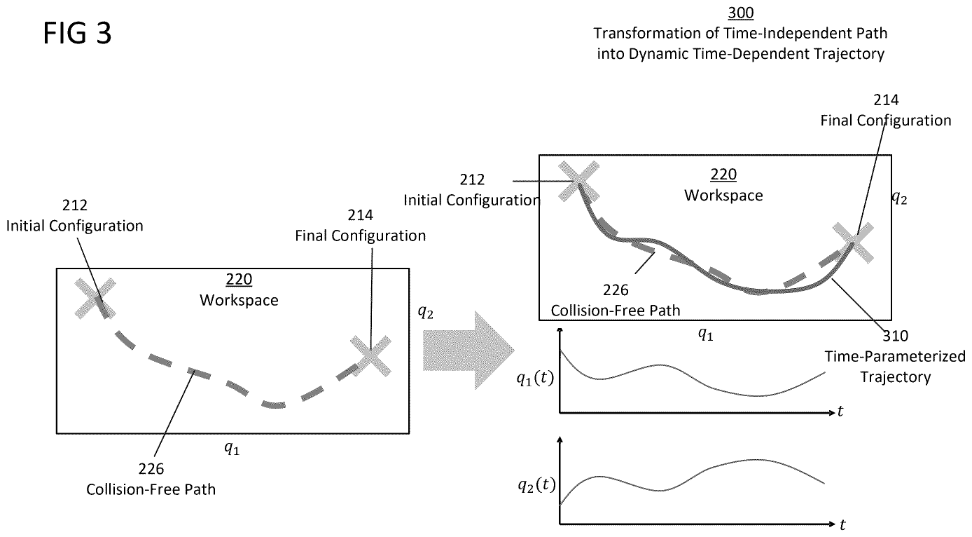

FIG. 3 illustrates a transformation 300 of a time-independent path into a dynamic time-dependent trajectory, in accordance with aspects of the disclosure.

The left-hand workspace 220 shows a path 226 (dashed line) connecting initial and final configurations 212, 214 (marked with yellow X's) in the q₁-q₂ coordinate space.

The right-hand workspace 220 demonstrates how this path 226, which is static, is transformed into a time-parameterized trajectory 310 (solid line) that incorporates dynamic constraints. The graphs, q₁(t) versus time and q₂(t) versus time, show the resulting time evolution of the joint coordinates q₁(t) and q₂(t), where the continuous curves represent how each joint angle varies over time while respecting velocity and acceleration limits.

This transformation process 300 generates a collision-free trajectory that satisfies two safety constraints: (1) the distance between the generated trajectory and the original path does not exceed a user-defined threshold, and (2) the higher-order dynamic variables (velocity, acceleration, etc.) remain within application-specific safety limits. The time-parameterized trajectory 310 enables the robot 210 to move smoothly between configurations 212, 214 while maintaining these safety guarantees.

The figure demonstrates how the virtual controller 150 transforms a purely geometric solution (the collision-free path 226) into a dynamically feasible motion plan (the trajectory 310) that accounts for the robot 210's physical limitations and safety requirements. This approach allows for aggressive yet safe robot motion by fully exploiting the system's dynamic capabilities while ensuring constraints are satisfied.

### II. Tethering-Based Trajectory Generation

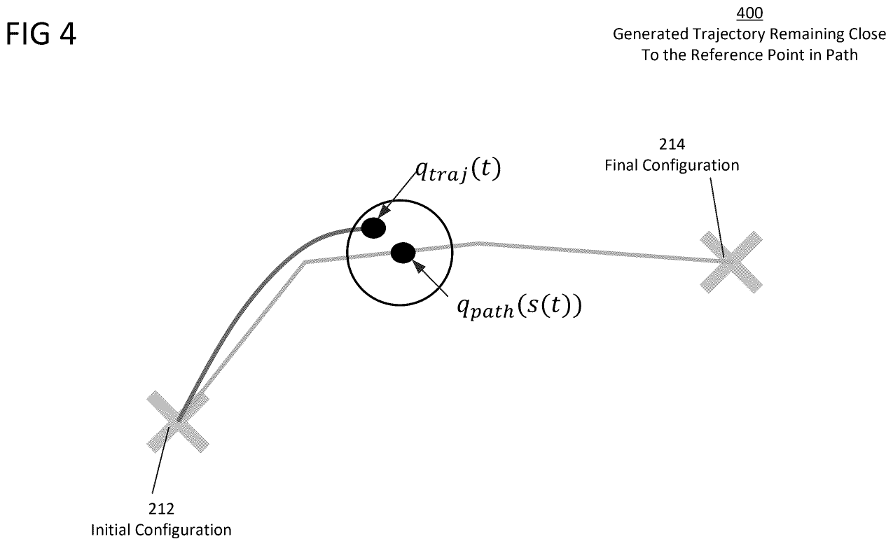

FIG. 4 illustrates a generated trajectory qₜᵣₐⱼ(t) that remains proximate to a reference point on the path qₚₐₜₕ(s(t)), in accordance with aspects of the disclosure.

An important aspect of the disclosed approach lies in a tethering-based mechanism for trajectory generation. In particular, the reference path 410 is parameterized by a scalar parameter s, such as arc length, which is endowed with a time dependence defined by:

$$\dot{s} ( t ) = v ( t ) \geq 0 , \qquad ( Equation 1 )$$

where \dot{s} denotes the time derivative of the path parameter s, and v(t) is a control input to be specified.

The point qₚₐₜₕ(s(t)), representing the position along the path at the current parameter value s(t), serves as a reference for a higher-order dynamical system described by:

$${q}_{traj}^{( r )} ( t ) = u ( t ) , \qquad ( Equation 2 )$$

where

$${q}_{traj}^{( r )} ( t )$$

denotes the r-th time derivative of the trajectory qₜᵣₐⱼ(t), and u(t) is a control input. For example, if only velocity is to be controlled, then r=1; if both velocity and acceleration are relevant, then r=2; and so on.

As illustrated in FIG. 4, the control inputs u(t) and v(t) are designed to ensure that to qₚₐₜₕ(s(t)) advances along the path, while qₜᵣₐⱼ(t) remains within a bounded region around it. In this way, the control input u(t) effectively tethers the actual trajectory to the reference path, while ensuring compliance with dynamic constraints of the system.

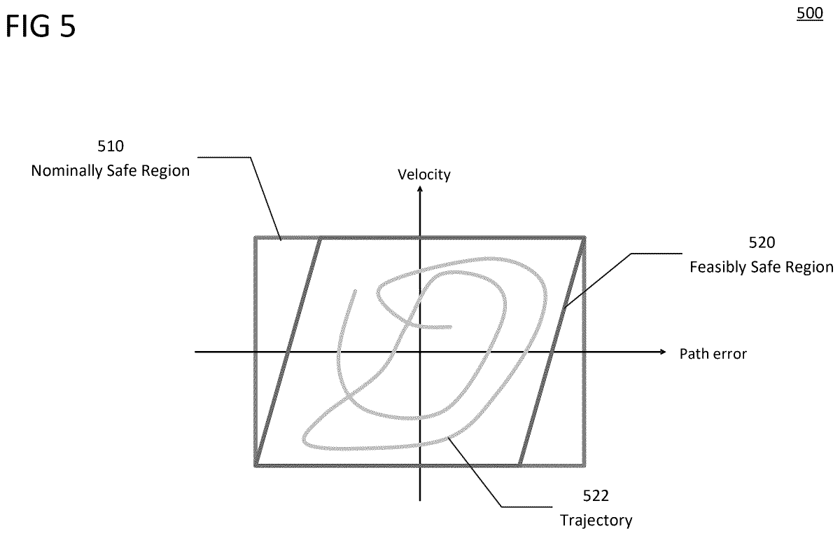

FIG. 5 illustrates a graph 500 depicting velocity as a function of path error, in accordance with aspects of the present disclosure. There is a feasible trajectory 522 in state space (e.g., path error and velocity), where remaining within the feasibly safe region 520 ensures \dot{s}(t)>0 and continued progression along the path.

“State space,” as used herein, refers to a multi-dimensional representation in which each dimension corresponds to a dynamic variable associated with the trajectory. In some aspects, the state space may include dimensions for path error, which represents the deviation between the generated trajectory and the reference path, as well as velocity. In some aspects, the state space may further include dimensions for acceleration and higher-order derivatives of the trajectory. The state space provides a framework for defining and enforcing constraints on the trajectory's dynamic behavior, where the feasibly safe region represents a bounded subset of the state space within which the trajectory is constrained to remain.

A nominally safe region 510 is defined based on the maximum allowable deviation from the reference path as specified by the user, as well as the maximum velocity constraints dictated by the problem formulation. Additional dimensions may be incorporated if constraints on acceleration or higher-order derivatives are to be considered.

In some aspects, the error threshold defining the maximum allowable deviation from the reference path may vary along the collision-free path. The path planner 140 may compute this variable error threshold based on obstacle proximity at each point along the path. For example, in regions where the path passes close to obstacles or collision regions 222, the path planner 140 may specify a tighter error tolerance (e.g., 1 cm), whereas in open areas with greater clearance from obstacles, a looser tolerance (e.g., 10 cm) may be permitted. This variable error threshold is output from the path planner 140 and provided to the safety controller 152, which uses the threshold to define the boundaries of the feasibly safe region at each point along the path. In this manner, the safety controller 152 may enforce position-dependent constraints that account for the varying proximity to obstacles throughout the trajectory.

For reasons related to system controllability, the nominally safe region 510 is reduced to a smaller region that is a tilted subset of the nominally safe region 510, referred to herein as the feasibly safe region 520. With a rectangular nominally safe region, if the trajectory reaches certain boundary points, such as near corners where both path error and velocity approach their respective limits, no control input may exist under the integrator dynamics (as described in Equations 1 and 2) that can drive the trajectory back inside the region. The tilted boundaries of the feasibly safe region 520 address this limitation by ensuring that from any point on the boundary, there exists a control input capable of pushing the trajectory back toward the interior of the region. Because the rectangular nominally safe region contains boundary points from which no valid control input exists under the system dynamics, whereas the tilted geometry of the feasibly safe region 520 eliminates such boundary points, the tilted subset increases controllability relative to the nominally safe region. This geometric modification guarantees that the safety controller 152 can always maintain the trajectory within the feasibly safe region 520 of the trajectory within the bounds of the region. In this manner, a non-zero slope within the feasibly safe region 520 ensures the existence of control inputs capable of maintaining the system within the bounds of the region.

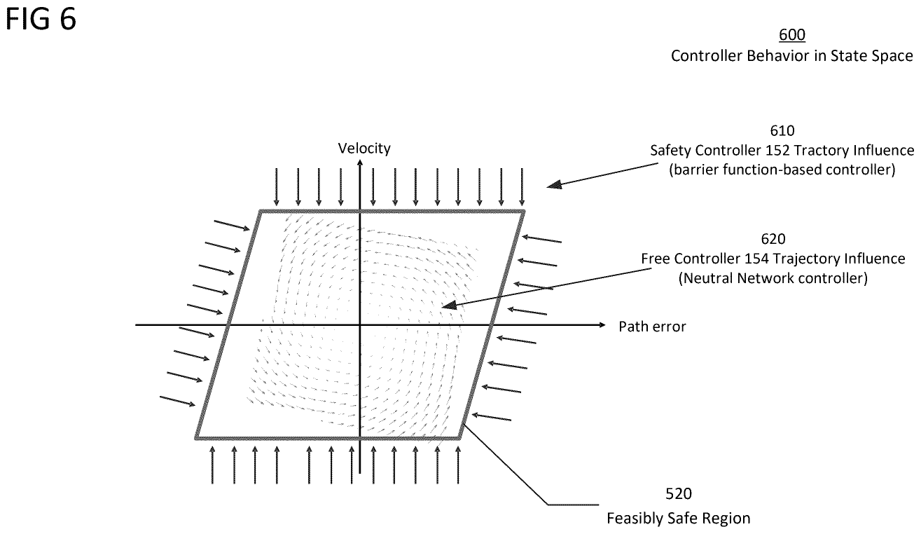

FIG. 6 illustrates a graph 600 depicting velocity as a function of path error of controller behavior in state space, in accordance with aspects of the disclosure

The safety controller 152 is configured to drive the system trajectory 610 within the bounds of the feasibly safe region 520 in state space. The control strategy employs a safety-enforcement mechanism that initiates operation when the trajectory reaches the boundary of the feasibly safe region 520. As described in further detail below, this approach allows any control policy to operate freely within the interior of the feasibly safe region 520. Accordingly, a free controller 154 (e.g., neural network-based) is employed within this feasibly safe region 520 to enhance trajectory performance 620.

### III. Safety-Enforcement Controllers

x denotes the augmented state of the trajectory, which includes not only the position in the workspace, but also higher-order derivatives such as velocity, acceleration, and potentially higher-order terms. Based on this state representation, the following controllers are defined:

$$u = g ( x ) , v = {g}^{s} ( s , x ) \qquad ( Equation 3 )$$

These controllers are designed as follows:

$$g ( x ) = {λ}_{α} ( {h}_{ε} ( x ) ) {g}_{safe} ( x ) + ( 1 - {λ}_{α} ( {h}_{ε} ( x ) ) ) {g}_{free} ( x ) \qquad ( Equations 4 )$$

$$( i , μ , σ ) = {arg min}_{j ∈ \{ 1 , … , r \} , v ∈ \{ 1 , … , m \} , σ ∈ \{ - , + \} )} {h}_{j , μ}^{( σ )} ( x ; {ϵ}_{j} )$$

$${g}_{sale} ( x ) = \{ \begin{matrix}- \frac{2 {C}_{r - 1} ( {x}_{i + 1 , μ} + ( - σ ) ϕ )}{{ϵ}_{i} {C}_{i - 1}} & i \neq r \\ ( - σ ) {C}_{r} {m}_{μ} & i = r\end{matrix}$$

$${λ}_{α} ( h ) = exp ( - α h ) , α \geq 0$$

$${g}_{free} ( x ) ∈ {\{ - {C}_{r} , {C}_{r} \}}^{m}$$

$${g}^{s} ( s , x ) = \{ \begin{matrix}( 1 - {λ}_{α} ( {h}_{ε} ( x ( t ) ) ) ) {g}_{free}^{s} ( x ) & s ( t ) < L \\ 0 & else\end{matrix}$$

$${g}_{free}^{s} ( x ) ∈ [ {\underline{g}}^{s} , {\overline{g}}^{s} ]$$

$${h}_{i , μ}^{( \pm )} ( x ; {ε}_{i} ) = \{ \begin{matrix}( 1 - \frac{{ε}_{i}}{2} ) {C}_{i - 1} ∓ \frac{{ε}_{i} {C}_{i - 1}}{2 {C}_{r - 1}} {x}_{r , μ} ∓ {x}_{i , μ} & i < r \\ {C}_{r - 1} ∓ {x}_{r , μ} & else\end{matrix}$$

$${h}_{ε} ( x ) = min {\{ {h}_{i , μ}^{( + )} ( x ; {ε}_{i} ) , {h}_{i , μ}^{( - )} ( x , {ε}_{i} ) \}}_{μ = 1 , i = 1}^{r , m}$$

where C₀ corresponds to the error threshold with respect to the path, C₁, . . . Cᵣ represent safety limits on higher-order state variables (e.g., velocity, acceleration, etc.). The parameter L denotes the total arc length of the path. The constraints εᵢ∈(0,1), φ, α>0 are design parameters. The term x_{i,μ} refers to the i-th time derivative of the μ-th coordinate for the robot's trajectory q_{μ}.

An intuitive explanation of the terms used in the controller design is provided below:

$${h}_{i , μ}^{+} and {h}_{i , μ}^{-} :$$

Define the boundaries (left and right, respectively) of the feasibly safe region for the state space coordinate corresponding to the i-th derivative of q_{μ}.

h_{ε}: Represents a signed distance metric between the current trajectory state and the boundary of the feasibly safe region boundary.

g_{safe}: A safety-enforcement controller that actively drives the system state toward the interior of the feasibly safe region when approaching its boundary.

g_{free}: An arbitrary, unconstrained controller used within the interior of the feasibly safe region. It is implemented, for example, as a neural network.

g: The actual control input applied to the system. It is constructed as a convex combination of the safety controller g_{safe} and the free controller g_{free}. When the state is near the boundary of the feasibly safe region, the actual control input g approximates the safety controller g_{safe} to ensure the trajectory remains within the feasibly safe region.

$${g}_{free}^{s} :$$

A free controller for the path parameter s(t), also implemented as a neural network. It is designed to be strictly positive to ensure that s increases, thereby ensuring continuous progression along the path to the terminal arc length L. However, as described below, the actual controller g^{s} blends this strictly positive output with zero, allowing path progression to pause temporarily when the trajectory approaches the boundary of the feasibly safe region.

g^{s}: The actual controller for s(t), defined as a convex combination of the free controller g_{free} and zero. When the system reaches the boundary of the feasibly safe region, g^{s} contribution may be reduced to zero, temporarily pausing path progression and allowing the trajectory to recover.

g^{s} and g̅^{s}: Lower and upper bounds, respectively, for g^{s}. These bounds are chosen to be positive, ensuring monotonic advancement along the path while satisfying safety constraints.

L: The total arc length of the path to be traversed.

The control framework satisfies the following properties: (1) The entire path is eventually traversed; (2) The deviation between the trajectory and the path does not exceed the user-defined predetermined threshold; (3) Higher order dynamical constraints (e.g., velocity, acceleration, etc.) are respected; and (4) The system remains within a minimally restrictive region of the state space (e.g., the tilted boxes in FIGS. 5 and 6), ensuring both feasibility and compliance with dynamic limits.

### IV. Learning-Based Free Controller

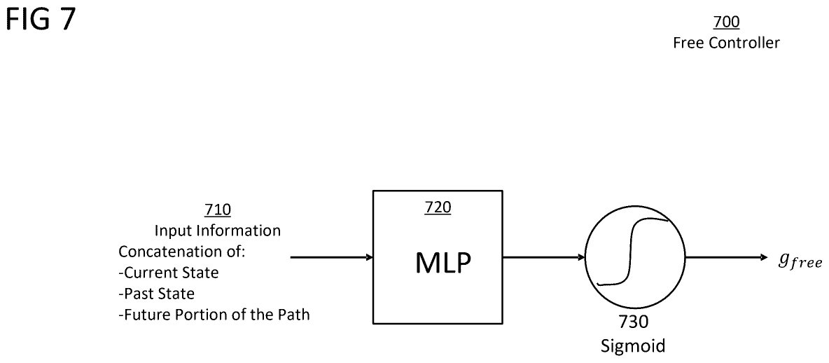

FIG. 7 illustrates a block diagram of a free controller 700 (154 in FIG. 1), in accordance with aspects of the disclosure.

The control framework described in the previous Safety Enforcement Controllers section permits the use of a free controller 700 within the interior of the feasibly safe region 522. Accordingly, a neural network-based controller enhances trajectory performance when the system state lies within this region.

The free controller 700 (154 in FIG. 1) receives relevant input information 710, including past system states and upcoming segments of the reference path. This input is processed by a multilayer perceptron (MLP) 720, which produces control outputs. A sigmoid activation function 730 is applied at the final layer to map the MLP output to a bounded range, ensuring that the control output remains within specified limits. This bounding guarantees compliance with the highest-order dynamic constraints, such as limits on velocity, acceleration, or other higher-order derivatives, as specified by the system requirements. By constraining the output in this manner, the free controller 700 generates control actions that satisfy the dynamic limits imposed on the robot's motion.

### V. Training

To train the neural networks described in the preceding learning-based free controller section, a Monte Carlo (MC) approach may be employed. In this scheme, multiple random paths are generated, and for each path, a corresponding trajectory is produced through simulation of the control system. The control architecture, regardless of the specific parameters of the neural network, ensures that generated trajectories remain feasible with respect to the defined safety constraints.

Each resulting trajectory is then evaluated using a performance index. To optimize traversal time, the objective can be framed as increasing the accumulated velocity, expressed as:

$$J = {\int }_{0}^{T} {\dot{q}}_{1}^{2} + ⋯ + {\dot{q}}_{n}^{2} dt , \qquad ( Equation 5 )$$

where q₁, . . . qₙ are the components of qₜᵣₐⱼ.

During training, simulations are conducted using the combined control scheme, comprising both the safety-enforcement controller and the free controller 154. In this configuration, the neural network is trained to improve performance by, for example, reducing the duration the system spends near the boundary of the feasibly safe region, where the neural controller is inactive and only the safety controller 152 is engaged.

### VI. Proof of Concept

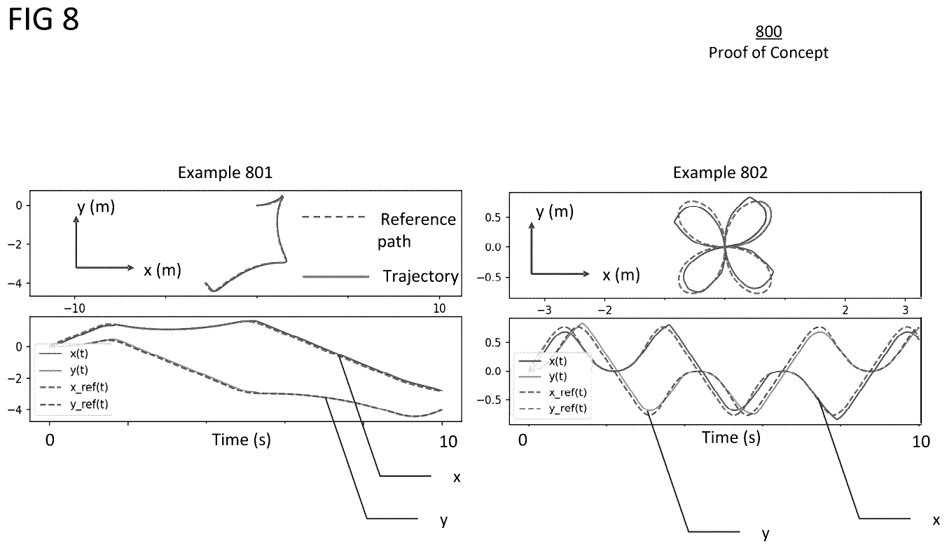

FIG. 8 illustrates a proof of concept 800 with examples 801 and 802 of trajectory generation applied to two paths with different shapes, in accordance with aspects of the disclosure.

As a proof of concept, the disclosed method was demonstrated in a two-dimensional (2D) workspace to facilitate visualization. The controllers were implemented as multilayer perceptrons (MLPs) with two hidden layers, comprising a total of 128 trainable parameters. FIG. 8 illustrates example results showing the behavior of the trajectory generation mechanism across paths of varying geometries.

Preliminary testing indicates that the generated trajectories are substantially less conservative compared to prior methods. Specifically, the disclosed approach achieves traversal time improvements ranging from 10× to 100× relative to quadratic programming (QP)-based and polynomial-based trajectory generation methods, with the magnitude of improvement depending on the path geometry and the constraints imposed on higher-order dynamical variables.

### VII. Online Replanning

The disclosed method enables efficient online trajectory replanning by integrating the evolution of a simplified dynamical system with a lightweight neural network-based controller. Unlike existing optimization-based approaches that involve solving complex computational problems at each replanning step, the disclosed aspects exploit the simplicity of the underlying dynamics to enable rapid trajectory adaptation. This allows for responsive operation under real-time constraints, accommodating environmental changes or unexpected obstacles. The neural network controller, trained to operate within a predefined feasibly safe region, efficiently computes corrective actions that satisfy safety constraints while imposing a lower computational load.

A feature of the disclosed approach is the causal, real-time nature of trajectory generation. The system evolves the trajectory based solely on the portion of the workspace path that has already been traversed, allowing the untraversed or future portion of the path to be updated dynamically without disrupting system operation. This decoupling enables localized replanning of only the remaining path segment in response to environmental changes. Because this replanning occurs in a reduced-dimensional space, and does not involve the full dynamic model, it is computationally efficient. The updated path integrates seamlessly with the ongoing trajectory, allowing for on-the-fly adjustments.

In contrast, many existing methods rely on online optimization frameworks that use simultaneous path replanning and trajectory optimization over a future time horizon. These optimization steps often dominate computational resources, making such methods unsuitable for resource-constrained platforms. For example, trajectory optimization stages can account for more than 60% of total computational effort in typical planning pipelines. By comparison, the aspects of this disclosure significantly reduce computational overhead by confining replanning to the path level while maintaining real-time adherence to trajectory dynamics, eliminating the need for additional optimization. This renders the disclosed aspects particularly well-suited for deployment on platforms with limited processing capabilities.

In addition to online replanning of the reference path, the disclosed system may support online retraining of the neural network-based free controller 154. Whereas replanning involves updating the collision-free path in response to environmental changes while maintaining the same trajectory generator, retraining involves adapting the weights of the neural network within the virtual controller 150. The training process may be performed online, adapting the controller using real-time data, which enables retraining of the neural network using environmental updates and sensor input. In some aspects, retraining may be triggered by sensor data indicating changed environmental conditions, real-time performance metrics showing degraded trajectory quality, or other operational factors. This distinction allows the system to respond to different types of changes: replanning addresses geometric changes in the environment, while retraining enables the free controller 154 to improve its performance characteristics based on operational experience.

The free controller 154 may incorporate sensor data and other real-time information for retraining purposes. Because the safety controller 152 continues to enforce hard constraints on the trajectory regardless of the free controller's behavior, the retraining process may proceed without compromising safety guarantees. The safety controller 152 maintains the trajectory within the feasibly safe region during and after any retraining of the free controller 154, ensuring that safety is preserved even as the neural network weights are updated. In some cases, the neural network weights may be updated incrementally during operation, allowing the free controller 154 to adapt to new path geometries, changed dynamic requirements, or other factors that affect trajectory performance. The lightweight architecture of the neural network, such as the multilayer perceptron with limited trainable parameters described herein, facilitates computationally efficient online retraining that may be performed on resource-constrained platforms.

### VIII. Compute System

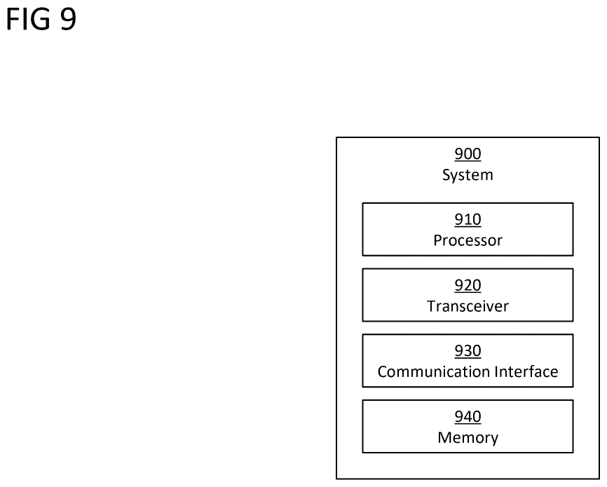

FIG. 9 illustrates a system 900 in accordance with aspects of the disclosure.

The system 900 may be identified with a central controller and be implemented as any suitable network infrastructure component, which may be implemented as a cloud/edge network server, controller, computing device, etc. The component 900 may include processor 910, a transceiver 920, a communication interface 930, and a memory 940. The components shown in FIG. 9 are provided for ease of explanation, and the component 900 may implement additional, fewer, or alternative components than those shown in FIG. 9.

The processor 910 may be operable as any suitable number and/or type of computer processor that may function to control the component 900. The processor 910 may be identified with one or more processors (or suitable portions thereof) implemented by the component 900. The processor 910 may be identified with one or more processors such as a host processor, a digital signal processor, one or more microprocessors, graphics processors, baseband processors, microcontrollers, an application-specific integrated circuit (ASIC), a portion (or the entirety of) a field-programmable gate array (FPGA), etc.

In any case, the processor 910 may be operable to execute instructions to perform arithmetic, logic, and/or input/output (I/O) operations and/or to control the operation of one or more components of the component 900 to perform various functions as described herein. The processor 910 may include one or more microprocessor cores, memory registers, buffers, clocks, etc. It may generate electronic control signals associated with the components of the component 900 to control and/or modify the operation of those components. The processor 910 may communicate with and/or control functions associated with the transceiver 920, the communication interface 930, and/or the memory 940. The processor 910 may additionally perform various operations to control the communications, communications scheduling, and/or operation of other network infrastructure components communicatively coupled to the component 900.

The transceiver 920 may be implemented as any suitable number and/or type of components operable to transmit and/or receive data packets and/or wireless signals in accordance with any suitable number and/or type of communication protocols. The transceiver 920 may include any suitable type of components to facilitate this functionality, including components associated with known transceiver, transmitter, and/or receiver operations, configurations, and implementations. Although shown as a transceiver in FIG. 9, the transceiver 920 may include any suitable number of transmitters, receivers, or combinations thereof, which may be integrated into a single transceiver or as multiple transceivers or transceiver modules. The transceiver 920 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 930 may be implemented as any suitable number and/or type of components operable to facilitate the transceiver 920 to receive and/or transmit data and/or signals in accordance with one or more communication protocols, as discussed herein. The communication interface 930 may be implemented as any suitable number and/or type of components operable to interface with the transceiver 920, such as analog-to-digital converters (ADCs), digital-to-analog converters, intermediate frequency (IF) amplifiers and/or filters, modulators, demodulators, baseband processors, and the like. The communication interface 930 may thus operate in conjunction with the transceiver 920 and form part of an overall communication circuitry implemented by the component 900, which may be implemented via the component 900 to transmit commands and/or control signals to perform any of the functions described herein.

The memory 940 is operable to store data and/or instructions such that when the instructions are executed by the processor 910, they cause the component 900 to perform various functions as described herein. The memory 940 may be implemented as any known volatile and/or non-volatile memory, including, for example, read-only memory (ROM), random access memory (RAM), flash memory, a magnetic storage medium, an optical disk, erasable programmable read-only memory (EPROM), programmable read-only memory (PROM), etc. The memory 940 may be non-removable, removable, or a combination of the two. The memory 940 may be implemented as a non-transitory computer-readable medium storing one or more executable instructions such as logic, algorithms, code, etc.

As further discussed below, the instructions, logic, code, etc., stored in the memory 940 are represented by the various modules/engines as shown in FIG. 9. Alternatively, when implemented via hardware, the modules/engines shown in FIG. 9 associated with the memory 940 may include instructions and/or code to facilitate control and/or monitoring of the operation of such hardware components. In other words, the modules/engines shown in FIG. 9 are provided to facilitate an explanation of the functional association between hardware and software components. Thus, the processor 910 may execute the instructions stored in these respective modules/engines in conjunction with one or more hardware components to perform the various functions discussed herein.

Various aspects described herein may utilize one or more machine learning models for the path planner 140 and controller 150. The term “model,” as used herein, may be understood to mean any type of algorithm that provides output data from input data (e.g., any type of algorithm that generates or calculates output data from input data). A machine learning model can be executed by a computing system to progressively improve the performance of a particular task. In some aspects, the parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be tuned during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, each of the machine learning models may utilize supervised learning, semi-supervised learning, unsupervised learning, or reinforcement learning techniques.

In supervised learning, the model may be built using a training set of data that includes both the inputs and the corresponding desired outputs (illustratively, each input may be associated with a desired or expected output for that input). Each training instance may include one or more inputs and a desired output. Training may involve iterating through training instances and using an objective function to teach the model to predict the output for new inputs (illustratively, for inputs not included in the training set). In semi-supervised learning, a portion of the inputs in the training set may lack corresponding desired outputs (e.g., one or more inputs may not be associated with any desired or expected output).

In unsupervised learning, the model may be built from a training set of data that includes only inputs and no desired outputs. The unsupervised model may be used to find structure in the data (e.g., grouping or clustering of data points), for example, by discovering patterns in the data. Techniques that may be implemented in an unsupervised learning model may, for example, self-organizing maps, nearest-neighbor mapping, k-means clustering, and singular value decomposition.

Reinforcement learning models may include positive or negative feedback to improve accuracy. A reinforcement learning model may attempt to maximize one or more goals/rewards. Techniques that may be implemented in a reinforcement learning model may include, for example, Q-learning, temporal difference (TD), and deep adversarial networks.

Various aspects described herein may utilize one or more classification models. In a classification model, outputs may be restricted to a limited set of values (e.g., one or more classes). The classification model may output a class for an input set of one or more input values. An input set may include sensor data, such as image data, radar data, LIDAR (light detection and ranging) data, and the like. A classification model as described herein may, for example, classify certain driving conditions and/or environmental conditions, such as weather conditions, road conditions, and the like. References herein to classification models may contemplate a model that implements, for example, one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (e.g., starting from or using an input set of one or more values). References herein to regression models may contemplate a model that implements, for example, one or more of the following techniques (or other suitable techniques): linear regression, decision trees, random forests, or neural networks.

A machine learning model described herein may be or include a neural network. The neural network may be any type of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network can have any number of layers. The training of the neural network (e.g., the adaption of the layers of the neural network) may use or be based on any kind of training principle, such as backpropagation (e.g., using the backpropagation algorithm).

The techniques of this disclosure may also be described in the following examples.

Example 1. A robotic system, comprising: a path planner configured to generate a collision-free path for a robot; and a virtual controller configured to generate a time-dependent trajectory based on the collision-free path, wherein the trajectory is tethered to the collision-free path subject to dynamic constraints of the robot, is constrained to remain within a feasibly safe region in state space, and is executable by the robot.

Example 2. The robotic system of example 1, wherein the virtual controller comprises: a safety controller configured to initiate operation when the trajectory reaches a boundary of the feasibly safe region, wherein the safety controller maintains at least position, velocity, and acceleration within predetermined safety constraint thresholds.

Example 3. The robotic system of any one or more of examples 1-2, wherein the virtual controller comprises: a free controller configured to operate within the feasibly safe region and generate control inputs based on past states and future path segments.

Example 4. The robotic system of example 3, wherein the free controller comprises a neural network controller.

Example 5. The robotic system of any one or more of examples 1-4, wherein: the collision-free path is defined by position coordinates; and the time-dependent trajectory incorporates position, velocity, and acceleration.

Example 6. The robotic system of any one or more of examples 1-5, wherein the virtual controller is configured to: update the collision-free path in real time in response to an environmental change; and regenerate the time-dependent trajectory based on the updated collision-free path, subject to the dynamic constraints of the robot.

Example 7. The robotic system of any one or more of examples 1-6, wherein the virtual controller is configured to: receive an error threshold defining a maximum distance between the trajectory and the collision-free path; and receive dynamic constraint threshold values for velocity and acceleration.

Example 8. The robotic system of any one or more of examples 1-7, wherein: the error threshold is variable along the collision-free path, and the virtual controller maintains the generated trajectory within the error threshold.

Example 9. The robotic system of any one or more of examples 1-8, wherein the virtual controller comprises: a safety controller configured to maintain the trajectory within the feasibly safe region; a neural network-based free controller configured to operate within the feasibly safe region; and an actual controller configured to generate a convex combination of outputs from the safety controller and the free controller, wherein the actual controller increases a contribution of the safety controller when the trajectory is within a predetermined distance from a boundary of the feasibly safe region.

Example 10. The robotic system of any one or more of examples 1-9, wherein the robot has n degrees of freedom, and the virtual controller is configured to scale trajectory generation efficiently with increasing n.

Example 11. The robotic system of any one or more of examples 1-10, wherein the feasibly safe region is derived from a nominally safe region defined by an allowable deviation from the collision-free path and a maximum velocity threshold, and comprises a tilted subset of the nominally safe region that increases controllability of the trajectory within bounds of the feasibly safe region in state space.

Example 12. At least one non-transitory computer-readable medium comprising instructions stored thereon, that if executed by one or more processors, cause the one or more processors to: generate a collision-free path for a robot; and generate a time-dependent trajectory based on the collision-free path, wherein the trajectory is tethered to the collision-free path subject to dynamic constraints of the robot, is constrained to remain within a feasibly safe region in state space, and is executable by the robot.

Example 13. The at least one non-transitory computer-readable medium of example 12, wherein the instructions further cause the one or more processors to: initiate operation of a safety controller when the trajectory reaches a boundary of the feasibly safe region, wherein the safety controller maintains at least position, velocity, and acceleration within predetermined safety constraint thresholds.

Example 14. The at least one non-transitory computer-readable medium of any one or more of examples 12-13, wherein the instructions further cause the one or more processors to: operate, by a free controller, within the feasibly safe region and generate control inputs based on past states and future path segments.

Example 15. The at least one non-transitory computer-readable medium of any one or more of examples 12-14, wherein the free controller comprises a neural network controller.

Example 16. The at least one non-transitory computer-readable medium of example any one or more of examples 12-15, wherein: the collision-free path is defined by position coordinates; and the time-dependent trajectory incorporates position, velocity, and acceleration.

Example 17. The at least one non-transitory computer-readable medium of any one or more of examples 12-16, wherein the instructions further cause the one or more processors to: update the collision-free path in real time in response to an environmental change; and regenerate the time-dependent trajectory based on the updated collision-free path, subject to the dynamic constraints of the robot.

Example 18. The at least one non-transitory computer-readable medium of any one or more of examples 12-17, wherein the instructions further cause the one or more processors to: receive an error threshold defining a maximum distance between the trajectory and the collision-free path; and receive dynamic constraint threshold values for velocity and acceleration.

Example 19. The at least one non-transitory computer-readable medium of any one or more of examples 12-18, wherein the instructions further cause the one or more processors to: maintain, by a safety controller, the trajectory within the feasibly safe region; operate, by a free controller, within the feasibly safe region; and generate a convex combination of outputs from the safety controller and the free controller, wherein the actual controller increases a contribution of the safety controller when the trajectory is within a predetermined distance from a boundary of the feasibly safe region.

Example 20. The at least one non-transitory computer-readable medium of any one or more of examples 1-19, wherein the feasibly safe region is derived from a nominally safe region defined by an allowable deviation from the collision-free path and a maximum velocity threshold, and comprises a tilted subset of the nominally safe region that increases controllability of the trajectory within bounds of the feasibly safe region in state space.

While the foregoing has been described in conjunction with exemplary aspects, the disclosure is intended to cover alternatives, modifications, and equivalents, which may be included within the scope of the disclosure. Although specific aspects have been illustrated and described herein, it will be appreciated by those of ordinary skill in the art that a variety of alternate and/or equivalent implementations may be substituted for the specific aspects shown and described without departing from the scope of the disclosure. The aspects of this disclosure are intended to cover any adaptations or variations of the specific aspects discussed herein.

1. A robotic system, comprising:
a path planner configured to generate a collision-free path for a robot; and
a virtual controller configured to generate a time-dependent trajectory based on the collision-free path,
wherein the trajectory is tethered to the collision-free path subject to dynamic constraints of the robot, is constrained to remain within a feasibly safe region in state space, and is executable by the robot.

2. The robotic system of claim 1, wherein the virtual controller comprises:
a safety controller configured to initiate operation when the trajectory reaches a boundary of the feasibly safe region,
wherein the safety controller maintains at least position, velocity, and acceleration within predetermined safety constraint thresholds.

3. The robotic system of claim 2, wherein the virtual controller comprises:
a free controller configured to operate within the feasibly safe region and generate control inputs based on past states and future path segments.

4. The robotic system of claim 3, wherein the free controller comprises a neural network controller.

5. The robotic system of claim 1, wherein:
the collision-free path is defined by position coordinates; and
the time-dependent trajectory incorporates position, velocity, and acceleration.

6. The robotic system of claim 1, wherein the virtual controller is configured to:
update the collision-free path in real time in response to an environmental change; and
regenerate the time-dependent trajectory based on the updated collision-free path, subject to the dynamic constraints of the robot.

7. The robotic system of claim 1, wherein the virtual controller is configured to:
receive an error threshold defining a maximum distance between the trajectory and the collision-free path; and
receive dynamic constraint threshold values for velocity and acceleration.

8. The robotic system of claim 7, wherein:
the error threshold is variable along the collision-free path, and
the virtual controller maintains the generated trajectory within the error threshold.

9. The robotic system of claim 1, wherein the virtual controller comprises:
a safety controller configured to maintain the trajectory within the feasibly safe region;
a neural network-based free controller configured to operate within the feasibly safe region; and
an actual controller configured to generate a convex combination of outputs from the safety controller and the free controller, wherein the actual controller increases a contribution of the safety controller when the trajectory is within a predetermined distance from a boundary of the feasibly safe region.

10. The robotic system of claim 1, wherein the robot has n degrees of freedom, and the virtual controller is configured to scale trajectory generation efficiently with increasing n.

11. The robotic system of claim 1, wherein the feasibly safe region is derived from a nominally safe region defined by an allowable deviation from the collision-free path and a maximum velocity threshold, and comprises a tilted subset of the nominally safe region that increases controllability of the trajectory within bounds of the feasibly safe region in state space.

12. At least one non-transitory computer-readable medium comprising instructions stored thereon, that if executed by one or more processors, cause the one or more processors to:
generate a collision-free path for a robot; and
generate a time-dependent trajectory based on the collision-free path,
wherein the trajectory is tethered to the collision-free path subject to dynamic constraints of the robot, is constrained to remain within a feasibly safe region in state space, and is executable by the robot.

13. The at least one non-transitory computer-readable medium of claim 12, wherein the instructions further cause the one or more processors to:
initiate operation of a safety controller when the trajectory reaches a boundary of the feasibly safe region,
wherein the safety controller maintains at least position, velocity, and acceleration within predetermined safety constraint thresholds.

14. The at least one non-transitory computer-readable medium of claim 13, wherein the instructions further cause the one or more processors to:
operate, by a free controller, within the feasibly safe region and generate control inputs based on past states and future path segments.

15. The at least one non-transitory computer-readable medium of claim 14, wherein the free controller comprises a neural network controller.

16. The at least one non-transitory computer-readable medium of claim 12, wherein:
the collision-free path is defined by position coordinates; and
the time-dependent trajectory incorporates position, velocity, and acceleration.

17. The at least one non-transitory computer-readable medium of claim 12, wherein the instructions further cause the one or more processors to:
update the collision-free path in real time in response to an environmental change; and
regenerate the time-dependent trajectory based on the updated collision-free path, subject to the dynamic constraints of the robot.

18. The at least one non-transitory computer-readable medium of claim 12, wherein the instructions further cause the one or more processors to:
receive an error threshold defining a maximum distance between the trajectory and the collision-free path; and
receive dynamic constraint threshold values for velocity and acceleration.

19. The at least one non-transitory computer-readable medium of claim 12, wherein the instructions further cause the one or more processors to:
maintain, by a safety controller, the trajectory within the feasibly safe region;
operate, by a free controller, within the feasibly safe region; and
generate a convex combination of outputs from the safety controller and the free controller, wherein the actual controller increases a contribution of the safety controller when the trajectory is within a predetermined distance from a boundary of the feasibly safe region.

20. The at least one non-transitory computer-readable medium of claim 12, wherein the feasibly safe region is derived from a nominally safe region defined by an allowable deviation from the collision-free path and a maximum velocity threshold, and comprises a tilted subset of the nominally safe region that increases controllability of the trajectory within bounds of the feasibly safe region in state space.
